(19) United States
(12) Patent Application Publication
(10) Pub. No.: US 2009/0121201 A1
(43) Pub. Date: May 14, 2009

(54) GREEN PIGMENT PREPARATIONS BASED ON C.I. PIGMENT GREEN 36

(75) Inventor: Joachim Jesse, Weisenheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/911,413

(22) PCT Filed: Apr. 24, 2006
(86) PCT No.: PCT/EP2006/061784

§ 371 Date: Oct. 12, 2007

(30) Foreign Application Priority Data
Apr. 25, 2005 (DE) 10 2005 019 400.1

(51) Int. Cl. G02B 5/23

(52) U.S. Cl. 252/586

(57) ABSTRACT

Green pigment preparations comprising as major constituents
(A) C.I. Pigment Green 36 or a mixture of C.I. Pigment Green 36 with one further, or two or more, green, yellow and/or blue pigment(s),
(B) at least one pigment derivative,
   and
(C) if desired, at least one surface-active agent different from (B),
   and also processes for producing them, and their use for producing the green component of color filters.

The present invention relates to green pigment preparations comprising as major constituents
(A) C.I. Pigment Green 36 or a mixture of C.I. Pigment Green 36 with one further, or two or more, green, yellow and/or blue pigment(s),
(B) at least one pigment derivative,
   and
(C) if desired, at least one surface-active agent different from (B).

The invention further relates to the production of these pigment preparations and to their use for producing the green component of color filters.

The red, green, and blue pigment preparations for color filters are customarily produced by mixing the pigments needed to generate the particular hue desired in the course of pigment finishing or in the course of pigment dispersing during paste manufacture. The pigment pastes are then converted by addition of binder, free-radically polymerizable monomers, photoinitiators, solvent, and further customary auxiliaries into radiation-curable inks (resist inks), which by means of appropriate printing techniques such as offset printing are applied directly in the desired patterned form to the glass plates used, for example, in LCD elements or else are applied first in the form of thin films to the glass plates which are subsequently converted, by photolithographic embossing, for example, to the desired red/green/blue pattern. The green pigment preparations used in the context of this procedure are based customarily on green and yellow or blue pigments. For optimum application in color filters there is a need for pigment preparations having high transparency, high chroma (cleanness of hue), and high color strength.

U.S. Pat. No. 5,821,016 prepares pigment dispersions for color filters by grinding the respective pigments, such as a mixture of C.I. Pigment Green 36 and C.I. Pigment Yellow 83 or C.I. Pigment Yellow 139, for example, in the presence of at least equal amounts up to twice the amount of a styrene/maleic acid-based dispersing resin, large amounts of an organic, glycol ether- or lactone-based solvent, and also, in some cases, small amounts of an additional dispersant in a bead mill. The millbase obtained is then converted directly to a resist ink. Among the dispersing assistants mentioned in the description, as well as the salts of polycarboxylic acids, are nonionic surface-active agents and also pigment derivatives, but these are not used in the examples.

In EP-A-902 327 there is no separate production of a pigment paste; instead, the radiation-sensitive dispersion is produced directly by the mixing of all of the components (pigments, binders, monomers, photoinitiator, solvents). The description mentions the possible use of anionic polymeric dispersing assistants and cationic, anionic, nonionic and amphoteric surface-active agents.

In U.S. Pat. No. 6,100,312 the pigments are first kneaded together with a special, dispersing graft copolymer, optionally an additional binder resin, and solvent. Then, following further addition of solvent, the kneaded material is subjected to ball milling or sand milling with glass beads, in which case dispersing assistants may also be added. Dispersing assistants mentioned in the description include anionic polymeric dispersants, surface-active agents, and phthalocyanine derivatives as well, but these are not used in the examples. Also specified are a range of red, green, and blue pigment mixtures, including a reference to the particular importance of yellow pigments based on isoindolene.

JP-A-2001-042117 describes green pigment dispersions for color filter application which are obtained by dispersing C.I. Pigment Green 36 and a C.I. Pigment Yellow 138, which has undergone salt kneading beforehand in the presence of maleic acid-modified rosin and polyethylene glycol, in γ-butyrolactone. Only in the description is it mentioned that the surface of the yellow pigment may have been subjected to treatment with a rosin, to an acidic or basic modification, or to a treatment with a pigment derivative.

Finally, in WO-A-03/035770, green pigment preparations are described which are produced by jointly salt-kneading a dry-salt-ground yellow pigment, Pigment Yellow 139 or 150 for example, and a green pigment, C.I. Pigment Green 36 for example, which may have been subjected beforehand likewise to dry salt grinding, in the presence of diacetone alcohol. After washing to remove salts and drying, the pigment mixture is then converted in the presence of a pigment derivative or of a polymeric surface-active agent into a dispersion in propylene glycol monomethyl ether, using a Dispermat, and then the binder polymer is added to the dispersion.

The known green pigment preparations, however, are unable to satisfy the profile of requirements for color filters. In particular, their transparency is usually inadequate.

It was an object of the invention to provide green pigment preparations which exhibit high chroma, high color strength, and, at the same time, high transparency.

Accordingly, pigment preparations have been found which comprise as major constituents
(A) C.I. Pigment Green 36 or a mixture of C.I. Pigment Green 36 with one further, or two or more, green, yellow and/or blue pigment(s),
(B) at least one pigment derivative, and
(C) if desired, at least one surface-active agent different from (B).

Also found has been a process for producing these pigment preparations, wherein the pigment (A) is subjected to salt kneading or salt grinding in the presence of the pigment derivative (B).

Found finally has been the use of the pigment preparations of the invention for producing the green component of color filters.

The pigment preparations of the invention are based on C.I. Pigment Green 36 alone or on mixtures of C.I. Pigment Green 36 with further green, yellow and/or blue pigments as component (A).

Examples that may be mentioned of the pigments additionally suitable as component (A) include C.I. Pigment Green 7, C.I. Pigment Yellow 83, 93, 94, 95, 109, 110, 128, 138, 139, 150, 166, and 185, and C.I. Pigment Blue 15:3 and 15:4.

Particular suitability is possessed here by mixtures of C.I. Pigment Green 36 with yellow pigments, especially with C.I. Pigment Yellow 138, 139, 150, and 185, with C. I. Pigment Yellow 138 and 150 being especially suitable mixing components.

The pigments (A) can be used in the form of the crude, as-synthesized pigments or in the form of pigments which have already been finished. For example, C.I. Pigment Green 36 can be employed in the form of crude pigment, produced in a synthesis performed by the method of DE-A-24 15 249, or in the form of finished pigment, subjected to a solvent finish in nitrophenol as described in DE-A-12 42 180.

As component (B) the pigment preparations of the invention preferably comprise a pigment derivative of the formula I sulfonic acid derivatives of copper phthalocyanine pigments and salts thereof. These derivatives preferably comprise 1.2 to 1.9 sulfo groups per molecule.

Examples of especially suitable components (B) are sulfonic acid derivatives of quinophthalone pigments and the alkaline earth metal salts thereof, examples being the magnesium and/or calcium salts, and ammonium salts, examples being the distearyldimethylammonium, distearylmethylammonium, stearyidimethylammonium, distearylammonium, stearylammonium, laurylammonium, and dehydroabietylammonium salts.

Since the green component in color filters is generally intended to have a yellowish green, yellow pigment derivatives are preferred as component (B).

Very particular preference is therefore given to the quinophthalone derivatives known from WO-A-02/00643, particularly, in turn, the sulfonic acid derivatives and salts thereof that are described therein.

Quinophthalone derivatives especially suitable as component (B) are derived from C.I. Pigment Yellow 138 and have the following formula Ia:

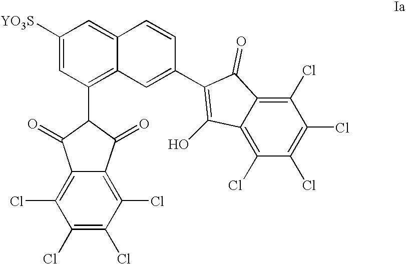

in which Y is hydrogen or is one of the above-defined cations M²⁺/2 or N⁺R¹R²R³R⁴.

It will be appreciated that the pigment preparations of the invention may also comprise mixtures of different pigment derivatives as component (B).

In general the pigment preparations of the invention comprise 1% to 20% by weight, preferably 4% to 12% by weight, of component (B), based on component (A).

As a further component (C), the pigment preparations of the invention may comprise a surface-active agent which is different from (B).

In the majority of cases, however, the pigment preparations comprising only components (A) and (B) already have the desired advantageous performance properties, so that there is no need to add component (C). If a component (C) is used, its amount is generally 0.1% to 99% by weight, in particular 2% to 30% by weight, based on components (A) and (B).

As component (C) it is possible to use anionic, nonionic cationic or amphoteric polymeric surface-active agents, preference being given to anionic and nonionic surface-active agents.

Suitable nonionic surface-active agents are based in particular on polyethers, i.e., on the alkoxylation products, particularly ethoxylation products and/or propoxylation products, of alcohols, amines, carboxylic acids, and carboxamides.

Examples of suitable anionic surface-active agents include the acidic phosphoric, phosphonic, sulfuric and/or sulfonic esters of polyethers.

Likewise suitable as anionic surface-active agents are addition polymers based on ethylenically unsaturated carboxylic acids, particularly the homopolymers and copolymers of ethylenically unsaturated monocarboxylic and/or dicarboxylic acids, such as (meth)acrylic acid and maleic acid, which may additionally comprise, in copolymerized form, the vinyl monomers not comprising an acid function, such as styrene, and also the alkoxylation products of these homopolymers and copolymers, and the salts of these polymers.

Finally, suitability is also possessed by anionic surface-active agents based on polyurethanes as component (C).

These surface-active agents are general knowledge and are available commercially, for example, under the names Tetronic® (BASF), Pluronic® (BASF), Nekal® (BASF), Tamol® (BASF), Crodafos® (Croda), Rhodafac® (Rhodia), Maphos® (BASF), Texapon® (Cognis), Empicol® (Albright & Wilson), Soprophor® (Rhodia), Lutensit® (BASF), Sokalan® (BASF), Joncryl® (Johnson Polymer), Alcosperse® (Alco), Geropon® (Rhodia), Good-Rite® (Goodrich), Orotan® (Rohm & Haas), Morez® (Rohm & Haas), Disperbyk® (Byk), Solsperse® (Lubrizol/Noveon), Tegospers® (Goldschmidt) and Borchi® (Borchers).

In addition it is also possible to use natural resins, rosin for example, and also modified natural resins, modified rosins for example, as surface-active agent (C).

It will be appreciated that mixtures of surface-active agents (C) can also be used.

The pigment preparations of the invention are obtainable advantageously by the production process that is likewise in accordance with the invention, and in which the pigment (A) is subjected to salt kneading or salt grinding in the presence of pigment derivative (B).

Surface-active agents (C) can be added to the pigment preparations of the invention, if desired, before, during or after the salt grinding or salt kneading. Where the pigment preparations of the invention are to comprise water-soluble surface-active agents, the latter are advantageously added or supplemented after the aqueous desalting of the kneaded or ground pigment preparation and its renewed slurrying in water. The aqueous preparation is subsequently freeze-dried or spray-dried.

In the production process of the invention, crystalline inorganic salts are used as milling salt. Use may be made of the salts or salt mixtures that are customary for salt kneading and salt grinding operations. Preference is given to sodium chloride and sodium sulfate.

The weight ratio of salt to the mixture of (A) and (B) may in this case be up to 12:1 and is preferably 3:1 to 9:1.

The salt kneading preferred in accordance with the invention is carried out in the presence of an organic solvent.

Particularly suitable organic solvents in this context include water-miscible organic solvents, especially relatively high-boiling solvents based on monomeric, oligomeric, and polymeric C₂-C₃ alkylene glycols and their C₁-C₄ alkyl ethers. The following may be mentioned by way of example: propylene glycol monomethyl and monoethyl ether, diethylene glycol, diethylene glycol monomethyl and monoethyl ether, triethylene glycol, triethylene glycol monomethyl and monoethyl ether, dipropylene glycol, dipropylene glycol monomethyl and monoethyl ether, and liquid polyethylene glycols and polypropylene glycols.

It is appropriate to use enough solvent to give a kneadable composition. Customarily about 10 to 45 ml of solvent are needed per 100 g of salt.

The salt kneading of the invention can be performed with cooling or heating at temperatures from below 0° C. to 180° C. Preferred kneading temperatures are 80 to 140° C.

The kneading time is generally 1 to 24 h, particularly 2 to 5 h.

Suitable kneading assemblies include, in particular, single-shaft and double-shaft kneaders and pan crushers.

The kneaded material obtained can be worked up in the customary way by stirred incorporation into water, isolation by filtration, washing with water, and drying. The dried product is appropriately subjected to grinding for deagglomeration in, for example, rotor grinding or jet grinding. Alternatively the aqueous filter cake may also be freeze-dried or spray-dried.

The salt grinding of the invention is preferably performed in the absence of an organic solvent. In certain cases, however, it may be advantageous to add an organic solvent in amounts of about 0.1% to 10% by weight, based on components (A) and (B). Examples that may be mentioned of suitable solvents include xylene, ethylene glycol, and dialkyl phthalates, dimethyl phthalate for example.

Salt grinding can be carried out in continuous or discontinuous ball mills, vibratory mills or attritors using the customary grinding beads and/or, if appropriate, beater bars.

The grinding temperatures are situated generally at room temperature to 130° C., preferably at 40 to 110° C.

The grinding times should be harmonized in each case with the grinding assembly used.

The grinding of the invention may take place in air but is preferably performed under inert gas.

The millbase obtained can be worked up in the same way as described for the salt kneading.

The pigment preparations of the invention are notable for high chroma and high color strength and also for high flocculation stability in the pastes and varnishes that are used for producing color filters, and in applied form, as a film or as a printed image, for example, exhibit high transparency.

They are therefore outstandingly suitable for producing the green component of color filters, such as are employed, for example, in LCD elements.

### EXAMPLES

### I) Production of Inventive Pigment Preparations

The following designations are used in the examples:

| | |
|---|---|
| Pigment (A1): | C.I. Pigment Green 36 with a bromine content |
| | of 59.0% by weight and a chlorine content of |
| | 5.3% by weight, prepared in the same way as |
| | in example 2 of DE-A-24 15 249 |
| Pigment | Monosulfonic acid of C.I. Pigment Yellow 138 of |
| derivative (B1): | formula la defined above, prepared as per example 1 of |
| | WO-A-02/00643 |
| Pigment | Copper phthalocyanine-sulfonic acid having 1.5 sulfo |
| derivative (B2): | groups per molecule |

### Example 1

A mixture of 1050 g of pigment (A1), 52.2 g of pigment derivative (B1), 5800 g of sodium sulfate and 950 g of triethylene glycol was kneaded in a 10-l high-speed kneader (Turbulent High-Speed Kneader TR 10 from Drais) at 130° C. (temperature of the kneaded composition) for 2 h.

The kneaded material obtained was stirred up in water, isolated by filtration and washed salt-free with water, then dried in a forced-air cabinet at 70° C. and ground using a rotor mill.

### Comparative Example C1

A mixture of 1000 g of pigment (A1), 5500 g of sodium sulfate and 1200 g of triethylene glycol was kneaded and worked up in the same way as in example 1.

### Example 2

A mixture of 40 g of pigment (A1), 2 g of pigment derivative (B1), 220 g of sodium sulfate and 36 g of triethylene glycol was kneaded in a high-performance laboratory kneader (Duplex laboratory kneader HKD-T 0.6 from IKA) at 130° C. for 2 h and worked up in the same way as in example 1.

### Example 3

A mixture of 40 g of pigment (A1), 2 g of pigment derivative (B1), a solution of 4 g of a polymeric surface-active agent (Solsperse® 32000; Lubrizol/Noveon) in 37 g of triethylene glycol, and 220 g of sodium sulfate was kneaded in the kneader from example 2 at 130° C. for 2 h and worked up in the same way as in example 1.

### Example 4

A mixture of 40 g of pigment (A1), 2 g of pigment derivative (B2), 220 g of sodium sulfate and 37 g of triethylene glycol was kneaded in the kneader from example 2 at 130° C. for 2 h and worked up in the same way as in example 1.

### Example 5

A mixture of 8.4 g of pigment (A1) and 0.42 g of pigment derivative (B1) was ground in a heatable 600-ml vibratory mill, which was filled with 1500 g of steel balls with a diameter of 25 mm, with 67.2 g of sodium chloride at 100° C. for 24 h.

The millbase obtained was introduced into 2 l of water. 2 ml of 20% strength by weight hydrochloric acid were added to the suspension, which was then stirred at 70° C. for 2 h. The pigment preparation was isolated by filtration, washed salt-free with water, dried in a forced-air cabinet at 70° C., and ground.

### Comparative Example C2

The procedure of example 5 was repeated but without using any pigment derivative.

### II) Testing of Inventive Pigment Preparations

The assessment of transparency and forward scattering was carried out with pigment pastes prepared as follows:

First of all a mixture of 6 g of an acrylate resin, 16 g of cyclohexanone and 13.6 g of propylene glycol monomethyl ether acetate was shaken in a 225-ml glass bottle in a Skandex dispersing apparatus (Lau) for 1 h. Then 6 g of the respective pigment preparation were dispersed in the resulting varnish with 200 g of zirconium dioxide beads (diameter 1.25 mm) in the Skandex for 3 h. Following dilution with 38.4 g of propylene glycol monomethyl ether acetate, dispersion in the Skandex was continued for a further 0.5 h.

The pigment pastes obtained following removal of the zirconium dioxide beads were drawn down as 12 μm films onto an acetate sheet, using a wire-wound doctor blade, and were vented at room temperature for 12 h.

To determine their transparency, the drawdowns were placed over black/white card. Visual assessment was made on the basis of a scale from 5 (substantial difference, i.e., substantially more transparent) to 0 (no difference, transparency the same), with the drawdowns prepared using the pigment preparations from the comparative examples serving as standards.

To determine the forward scattering, the drawdowns were subjected to measurement using a Cary 5E spectrophotometer (Varian) using the measurement geometry open Ulbricht sphere.

The fraction of the forward scattering, i.e., the fraction of light broken away from the perpendicular when light is beamed through a sample, is a measure of the fine division of the color pigment and of its distribution in the drawdown. The finer the pigment particles, the narrower the particle size distribution, and the more effectively the pigment particles are dispersed in the drawdown, the lower the fraction of forward scattering.

The results obtained are compiled in the table which follows.

TABLE

| Pigment preparation from | Transparency | Forward scattering |
|---|---|---|
| Example 1 | 2 | 3.3% |
| Comparative example C1 | standard | 5.4% |
| Example 2 | 3 | 2.9% |
| Example 3 | 3 | 3.0% |
| Example 4 | 3 | 3.1% |
| Example 5 | 0 | 3.8% |
| Comparative example C2 | standard | 7.1% |

1-14. (canceled)

15. A green pigment preparation comprising as major constituents
(A) C.I. Pigment Green 36,
(B) at least one pigment derivative, selected from the group of the sulfonic acid derivatives of quinophtalone pigments,
and
(C) if desired, at least one surface-active agent different from (B),
obtainable by salt kneading or salt grinding of pigment (A) in the presence of pigment derivative (B).

16. The pigment preparation according to claim 15, comprising as component (B) a mixture of the pigment derivative selected from the group of the sulfonic acid derivatives of quinophtalone pigments with one or more pigment derivative of the formula I 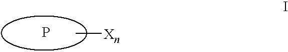
in which the variables have the following definitions:
P is the radical of a pigment from the group of anthanthrone, anthraquinone, anthrapyrimidine, azo, quinacridone, quinophthalone, diketopyrrolopyrrole, dioxazine, flavanthrone, indanthrone, isoindoline, isoindolinone, isoviolanthrone, metal complex, perinone, perylene, phthalocyanine, pyranthrone, pyrazoloquinazolone, thioindigo, and triarylcarbonium pigments;
X is —SO₃H, —SO₃⁻M⁺, —SO₃⁼N⁺R¹R²R³R⁴, —SO₂NR¹R², —CH₂NR¹R², —CH₂R⁵, —COOH, —COO⁻M⁺ or —COO⁻N⁺R¹R²R³R⁴;
M⁺ is the equivalent of a metal cation;
R¹, R², R³, and R⁴ independently of one another are:
hydrogen; C₁-C₂₂ alkyl or C₂-C₂₂ alkenyl whose carbon chain may be interrupted in each case by one or more moieties —O—, —S—, —NR⁶—, —CO— or —SO₂— and/or which may be substituted one or more times by hydroxyl, halogen, aryl, C₁-C₄ alkoxy and/or acetyl; C₃-C₈ cycloalkyl whose carbon framework may be interrupted by one or more moieties —O—, —S—, —NR⁶— or —CO— and/or which may be substituted one or more times by hydroxyl, halogen, aryl, C₁-C₄ alkoxy and/or acetyl; dehydroabietyl or aryl; R¹ and R², or R¹, R² and R³, together, are a 5- to 7-membered cyclic radical which comprises the nitrogen atom and which may comprise further heteroatoms;
R⁵ is a radical 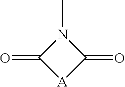
R⁶ is hydrogen or C₁-C₄ alkyl;
A is arylene which may be substituted by halogen, arylsulfonyl or —COR⁷ or —CO—C₆H₄—CO—;
R⁷ is C₁-C₄ alkyl or phenyl; and
n is an integral or fractional number from 1 to 4.

17. The pigment preparation according to claim 15, comprising as component (B) a pigment-sulfonic acid or an alkaline earth metal salt or ammonium salt thereof.

18. The pigment preparation according to claim 15, comprising as component (B) a sulfonic acid of C.I. Pigment Yellow 138 or an alkaline earth metal salt or ammonium salt thereof.

19. The pigment preparation according to claim 15, comprising 1% to 20% by weight of component (B), based on component (A).

20. The pigment preparation according to claim 15, comprising 0.1% to 99% by weight of component (C), based on components (A) and (B).

21. The pigment preparation according to claim 15, comprising component (A) and component (B).

22. A process for producing a pigment preparation according to claim 15, which comprises subjecting pigment (A) to salt kneading or salt grinding in the presence of pigment derivative (B).

23. A process for producing a pigment preparation according to claim 15, which comprises subjecting pigment (A) to salt kneading or salt grinding in the presence of pigment derivative (B), wherein before, during or after the salt kneading or salt grinding a polymeric surface-active agent is added.

24. A process for producing a pigment preparation according to claim 15, which comprises subjecting pigment (A) to salt kneading in the presence of pigment derivative (B), wherein the salt kneading is carried out with a crystalline inorganic salt in the presence of an organic solvent.

25. A process for producing a pigment preparation according to claim 15, which comprises subjecting pigment (A) to salt kneading in the presence of pigment derivative (B), wherein the salt kneading is carried out in single-shaft or double-shaft kneaders or pan crushers.

26. A process for producing a pigment preparation according to claim 15, which comprises subjecting pigment (A) to salt grinding in the presence of pigment derivative (B), wherein the salt grinding is carried out with a crystalline inorganic salt in the presence if desired of an organic solvent.

27. A process for producing a pigment preparation according to claim 15, which comprises subjecting pigment (A) to salt grinding in the presence of pigment derivative (B), wherein the salt grinding is carried out in continuous or discontinuous ball mills, vibratory mills or attritors.

28. A method for producing the green component of a color filter, comprising the step of applying a pigment preparation according to claim 15.
